(19) United States
(12) Patent Application Publication
(10) Pub. No.: US 2026/0171105 A1
(43) Pub. Date: Jun. 18, 2026

(54) ELECTRONIC DEVICE AND METHOD FOR CONTROLLING THE SAME

(71) Applicant: SAMSUNG ELECTRONICS CO., LTD., Suwon-si (KR)

(72) Inventors: Yoonjae LEE, Suwon-si (KR); Dongwoo KIM, Suwon-si (KR); Hyeonsik JEONG, Suwon-si (KR); Inwoo HWANG, Suwon-si (KR); Sunmin KIM, Suwon-si (KR); Hanki KIM, Suwon-si (KR)

(73) Assignee: SAMSUNG ELECTRONICS CO., LTD., Suwon-si (KR)

(21) Appl. No.: 19/343,460

(22) Filed: Sep. 29, 2025

Related U.S. Application Data
(63) Continuation of application No. PCT/KR2025/014393, filed on Sep. 16, 2025.

(30) Foreign Application Priority Data
Dec. 12, 2024 (KR) 10-2024-0184405

(51) Int. Cl. G10L 21/0308; G10L 21/0316

(52) U.S. Cl. CPC G10L 21/0308; G10L 21/0316

(57) ABSTRACT

An electronic device that activates a text to speech (TTS) function, obtains a first audio signal generated in response to playing video content, obtains a second audio signal generated in response to activating the TTS function, in response to activating the TTS function, classifies the first audio signal into a first audio object and a second audio object, determines a first weight for the first audio object and a second weight for the second audio object, and synthesizes and outputs the first audio object with the first weight applied thereto, the second audio object with the second weight applied thereto, and the second audio signal. The first audio object may be a signal of a type similar to the second audio signal compared to the second audio object, and the first weight and the second weight may be different.

### CROSS-REFERENCE TO RELATED APPLICATIONS

This application is a by-pass continuation application of International Application No. PCT/KR2025/014393, filed on Sep. 16, 2025, which is based on and claims priority to Korean Patent Application No. 10-2024-0184405, filed on Dec. 12, 2024, in the Korean Intellectual Property Office, the disclosures of which are incorporated by reference herein their entireties.

### TECHNICAL FIELD

An embodiment of the disclosure relates to an electronic device and a method for controlling the same.

### BACKGROUND ART

With the development of electronic technology, the electronic devices providing various functions are being developed. For example, technology for separating audio objects from audio data is being developed, and particularly, recently, techniques for separating audio objects such as human voices from audio data using various deep learning technologies are being developed.

Further, voice synthesis technology called text-to-speech (TTS) is being utilized in various technical fields, including interactive personal assistants, artificial intelligence speakers, and robotics, along with voice separation technology.

While video content is being played on an electronic device, a circumstance may occur where voices are overlapped and output due to activation of a TTS function. For example, when the user is watching video content, in a circumstance in which the electronic device receives a message and outputs the message content as voice by activation of the TTS function, the voice of the content and the voice of the message may overlap each other, which may result in decreased immersion of the user in the content. Further, the user may not be able to understand the content of the message output as voice due to activation of the TTS function. Therefore, there is a need for balancing a voice signal output from content and a voice signal output by the TTS function. This may be referred to as audio ducking technology. Audio ducking may be used to automatically reduce the volume of one audio signal in response to another audio signal.

The above-described information may be provided as related art for the purpose of helping understanding of the disclosure. No claim or determination is made as to whether any of the foregoing is applicable as background art in relation to the disclosure.

### DISCLOSURE OF INVENTION

An electronic device according to an embodiment of the disclosure may provide audio ducking technology for harmoniously balancing sound between voice signals when outputting a plurality of voice signals.

An electronic device according to an embodiment of the disclosure may include one or more processors, and memory storing instructions. The instructions may, when executed individually or collectively by the one or more processors, cause the electronic device to activate a text to speech (TTS) function, obtain a first audio signal generated in response to playing video content, obtain a second audio signal generated in response to activating the TTS function, in response to activating the TTS function, classify the first audio signal into a first audio object and a second audio object, determine a first weight for the first audio object and a second weight for the second audio object wherein the first weight and the second weight are different, apply the first weight to the first audio object and the second weight to the second audio object, synthesize the first audio object with the first weight applied thereto, the second audio object with the second weight applied thereto, and the second audio signal together into a synthesized audio signal, and output the synthesized audio signal. The first audio object and the second audio signal may correspond to a same type of signal, and the second audio object may correspond to a different type of signal than the first audio object and the second audio signal.

A method my include activating a text to speech (TTS) function, obtaining a first audio signal generated in response to playing video content, obtaining a second audio signal generated in response to activating the TTS function, in response to activating the TTS function, classifying the first audio signal into a first audio object and a second audio object, determining a first weight for the first audio object and a second weight for the second audio object wherein the first weight and the second weight are different, applying the first weight to the first audio object and the second weight to the second audio object, synthesizing the first audio object with the first weight applied thereto, the second audio object with the second weight applied thereto, and the second audio signal together into a synthesized audio signal, and outputting the synthesized audio signal. The first audio object and the second audio signal may correspond to a same type of signal, and the second audio object may correspond to a different type of signal than the first audio object and the second audio signal.

An electronic device according to an embodiment of the disclosure may separate audio objects for each voice signal and adjust and output sound for audio objects with high relevance when outputting a plurality of voice signals.

An electronic device according to an embodiment of the disclosure may increase the user's immersion when watching videos by outputting separated audio objects with different weights applied thereto.

The disclosure is not limited to the foregoing embodiments but various modifications or changes may rather be made thereto without departing from the spirit and scope of the disclosure.

### BRIEF DESCRIPTION OF DRAWINGS

FIG. 1 is a block diagram briefly illustrating a functional configuration of an electronic device according to an embodiment of the disclosure.

FIG. 2 is a block diagram illustrating in detail a functional configuration of an electronic device according to an embodiment of the disclosure.

FIG. 3 is a functional block diagram for an electronic device according to an embodiment of the disclosure to separate some of a plurality of audio signals by audio object and synthesize and output the separated audio objects.

FIG. 4 illustrates a process in which an electronic device according to an embodiment of the disclosure performs object-specific audio ducking on an audio signal.

FIG. 5 illustrates a process in which an electronic device according to an embodiment of the disclosure performs object-specific audio ducking on an audio signal.

FIG. 6 is a schematic control flowchart for an electronic device according to an embodiment of the disclosure to perform an object-specific audio ducking technique.

FIG. 7 is a control flowchart for an electronic device according to an embodiment of the disclosure to perform an object-specific audio ducking technique.

FIG. 8 is a control flowchart for an electronic device according to an embodiment of the disclosure to perform an object-specific audio ducking technique.

FIG. 9 is a control flowchart for an electronic device according to an embodiment of the disclosure to perform an object-specific audio ducking technique.

FIG. 10 exemplarily illustrates a scenario in which an electronic device according to an embodiment of the disclosure performs object-specific audio ducking.

FIG. 11 exemplarily illustrates a scenario in which an electronic device according to an embodiment of the disclosure performs object-specific audio ducking.

FIG. 12 exemplarily illustrates a scenario in which an electronic device according to an embodiment of the disclosure performs object-specific audio ducking.

### MODE FOR THE INVENTION

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “A, or B”, “at least one of A and B,” “at least one of A, and B”, “at least one of A or B,” “at least one of A, or B”, “A, B, or C,” “A, B or C”, “at least one of A, B, and C,” “at least one of A, B and C”, “at least one of A, B, or C,” “at least one of A, B or C”, may include all possible combinations of the items enumerated together in a corresponding one of the phrases. As an example, a phrase such as “at least one of A, B, and C”, as used herein, includes any of the following: A, B, C, A and B, A and C, B and C, A and B and C. As used herein, such terms as “1st” and “2nd,” or “first” and “second” may be used to simply distinguish a corresponding component from another, and does not limit the components in other aspect (e.g., importance or order).

In the disclosure, the terms “front and rear direction”, “left and right direction”, and “upper and lower direction” to be used below may be used with respect to the illustrated drawings, and the shape and position of each component are not limited thereto.

According to an embodiment, each component (e.g., a module or a program) of the above-described components may include a single entity or multiple entities. Some of the plurality of entities may be separately disposed in different components.

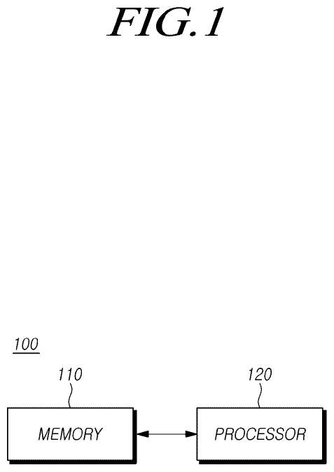

FIG. 1 is a block diagram briefly illustrating a functional configuration of an electronic device 100 according to an embodiment of the disclosure.

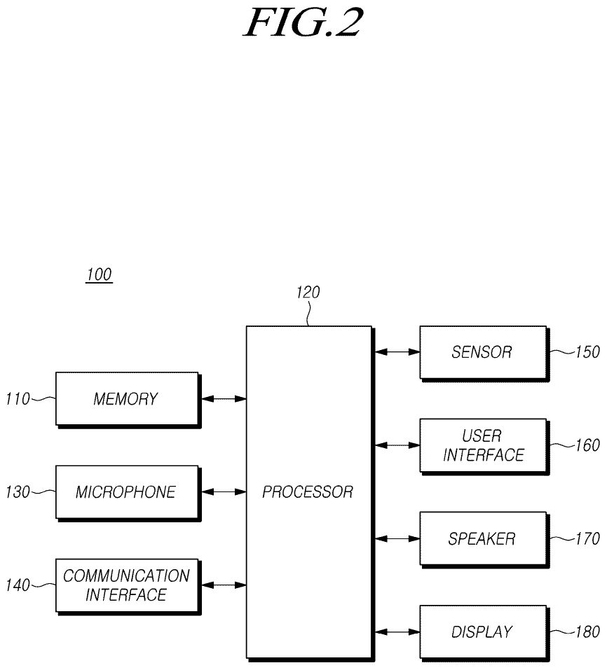

FIG. 2 is a block diagram illustrating in detail a functional configuration of the electronic device 100 according to an embodiment of the disclosure.

Referring to FIGS. 1 and 2, the electronic device 100 according to an embodiment of the disclosure may include memory 110 and a processor 120. The memory 110 may be configured to store or memorize programs and/or data for controlling each component of the electronic device 100. The processor 120 may be configured to generate control signals for controlling each component of the electronic device 100 based on programs and/or data stored in the memory 110 and information obtained from other components.

According to an embodiment, the electronic device 100 may further include a microphone 130, a communication interface 140, a sensor 150, a user interface 160, a speaker 170, and a display 180, in addition to the memory and the processor 120. However, this is exemplary, and in implementing the disclosure, in addition to the above-described components, new components may be added or some components may be omitted.

According to an embodiment, the memory 110 may store at least one instruction related to the electronic device 100. For example, the memory 110 may store an operating system (OS) for driving the electronic device 100. For example, the memory 110 may store various software programs or applications for operating the electronic device 100 according to various embodiments of the disclosure. At least some of the application programs stored in the memory 110 may be downloaded from an external server through wireless communication. At least some of the application programs stored in the memory 110 may be stored in the memory 110 from the time of shipment for default functions of the electronic device 100.

According to an embodiment, the memory 110 may include a semiconductor memory such as a flash memory, a magnetic storage medium such as a hard disk, or the like.

According to an embodiment, various software modules for the electronic device 100 to operate according to various embodiments of the disclosure may be stored in the memory 110, and the processor 120 may control the operation of the electronic device 100 by executing various software modules stored in the memory 110. In other words, the memory 110 is accessed by the processor 120, and reading, writing, modification, deletion, and/or update of data by the processor 120 may be performed.

According to an embodiment, in the disclosure, the term “memory 110” may be used as a meaning including memory, read only memory (ROM) and random access memory (RAM) in the processor 120, or a memory card (e.g., a micro secure digital (SD) card or a memory stick) mounted on the electronic device 100.

According to an embodiment, a plurality of text-to-speech (TTS) databases and a plurality of weight sets may be stored in the memory 110, and voice data, text data, and/or a plurality of parameter information according to various embodiments of the disclosure may be stored.

According to an embodiment, an artificial intelligence model to be described below may be implemented as software and stored in the memory 110, and the processor 120 may control voice recognition, voice extraction (or classification), and voice synthesis processes according to the disclosure by executing the software stored in the memory 110.

According to an embodiment, the processor 120 may be connected to one or more components included in the electronic device 100 to control the overall operation of the electronic device 100. The processor 120 may include one or more processors.

According to an embodiment, when a method according to the disclosure includes a plurality of operations, the plurality of operations may be performed by one processor or may be performed by a plurality of processors. For example, when a first operation, a second operation, and a third operation are performed by the method according to the disclosure, all of the first operation, the second operation, and the third operation may be performed by a first processor, or the first operation and the second operation may be performed by a first processor (e.g., a general-purpose processor) and the third operation may be performed by a second processor (e.g., an artificial intelligence dedicated processor).

According to an embodiment, the processor 120 may be implemented as a single-core processor including one core, or may be implemented as one or more multi-core processors including a plurality of cores (e.g., homogeneous multi-core or heterogeneous multi-core). When one or more processors 120 are implemented as a multi-core processor, each of the plurality of cores included in the multi-core processor may include memory disposed inside the processor, such as cache memory and on-chip memory, and a common cache shared by the plurality of cores may be included in the multi-core processor. Further, each of the plurality of cores included in the multi-core processor (or some of the plurality of cores) may independently read and execute program instructions for implementing a method according to an embodiment of the disclosure, or all (or some) of the plurality of cores may be linked to read and execute program instructions for implementing a method according to an embodiment of the disclosure.

According to an embodiment, when a method according to the disclosure includes a plurality of operations, the plurality of operations may be performed by one core among the plurality of cores included in the multi-core processor, or may be performed by a plurality of cores. For example, when a first operation, a second operation, and a third operation are performed by the method according to the disclosure, all of the first operation, the second operation, and the third operation may be performed by a first core included in the multi-core processor, or the first operation and the second operation may be performed by a first core included in the multi-core processor and the third operation may be performed by a second core included in the multi-core processor.

According to an embodiment, one or more processors 120 may mean a system on chip (SoC) in which one or more processors and other electronic components are integrated, a single-core processor, a multi-core processor, or cores included in the single-core processor or the multi-core processor, where the cores may be implemented as CPU, GPU, APU, MIC, NPU, hardware accelerator, or machine learning accelerator, but embodiments of the disclosure are not limited thereto. However, hereinafter, for convenience of description, the operation of the electronic device 100 is described with the expression processor 120.

According to an embodiment, the processor 120 may be implemented in various types. For example, the processor 120 may be implemented as at least one of an application specific integrated circuit (ASIC), an embedded processor, a microprocessor, hardware control logic, a hardware finite state machine (FSM), and a digital signal processor (DSP).

In an embodiment, one or more processors 120 may control to process input data according to predefined operation rules or artificial intelligence models stored in the memory 110. For example, when one or more processors 120 are artificial intelligence dedicated processors, the artificial intelligence dedicated processors may be designed with a hardware structure specialized for processing specific artificial intelligence models. The predefined operation rules or artificial intelligence models may be created through learning. For example, being created through learning means that predefined operation rules or artificial intelligence models configured to perform desired characteristics (or purposes) are created by training a basic artificial intelligence model using a plurality of learning data by a learning algorithm. Such learning may be performed in the device itself where artificial intelligence according to the disclosure is performed, or may be performed through a separate server and/or system. Learning algorithms may include, but are not limited to, e.g., supervised learning, unsupervised learning, semi-supervised learning, or reinforcement learning. An artificial intelligence model may be composed of a plurality of neural network layers. Each of the plurality of neural network layers has a plurality of weight values, and may perform neural network computation through computation between a computation result of a previous layer and the plurality of weight values. The plurality of weight values of the plurality of neural network layers may be optimized by learning results of the artificial intelligence model. For example, the plurality of weight values may be updated so that loss values or cost values obtained from the artificial intelligence model during the learning process are decreased or minimized.

According to an embodiment, the microphone 130 may receive user voice according to the user's utterance, and the received user voice may correspond to a control command for controlling the operation of the electronic device 100.

According to an embodiment, the communication interface 140 may perform communication with external devices or servers. For example, the communication interface 140 may include at least one of a Wi-Fi chip, a Bluetooth chip, a wireless communication chip, and an NFC chip. The communication interface 140 may be implemented as a communication circuitry.

According to an embodiment, the communication interface 140 may perform communication connection to external devices or servers and may receive user voice signals from the external devices or servers. For example, user voice may be received not only through the microphone 130 but also through the communication interface 140.

According to an embodiment, the sensor 150 may be configured to detect various types of information. For example, the sensor 150 may include a touch sensor that detects the user's touch, and the sensor 150 may also include various sensors such as a motion sensor, a temperature sensor, a humidity sensor, and an illuminance sensor.

According to an embodiment, the user interface 160 may receive user interactions for controlling the overall operation of the electronic device 100. For example, the user interface 160 may be implemented with components such as a camera, the microphone 130, and a remote control signal receiver. For example, the user interface 160 may be implemented as a touch screen included in the display 180.

According to an embodiment, the speaker 170 may output voice. For example, the processor 120 may control the speaker 170 to output voice. For example, the speaker 170 may output an output voice corresponding to obtained text. For example, the speaker 170 may output various notification sounds or voice messages in addition to various audio data processed by the processor 120.

According to an embodiment, the display 180 may output images. And the processor 120 may control the display 180 to output images. For example, the processor 120 may control the display 180 to display text information corresponding to output voice according to the disclosure.

Although not illustrated, the electronic device 100 may further include a camera. For example, the camera may be configured to capture still images or moving images. For example, the camera may capture still images at specific times. For example, the camera may continuously capture still images.

According to an embodiment, when a voice signal is output, the electronic device 100 may separate the voice signal into a plurality of audio object signals. For example, the electronic device 100 may separate the voice signal into an object indicating a voice component and an object indicating a background music component. For example, the electronic device 100 may separate voice signals based on an artificial intelligence learning model.

According to an embodiment, while voice is output according to video (or audio) content playback, the electronic device 100 may simultaneously output additional voice according to activation of the TTS function. For example, while the electronic device 100 outputs a voice signal according to video content playback, the electronic device 100 may output a voice signal of a message received by the electronic device 100 through the TTS function. For example, when the electronic device 100 plays video content including foreign language (e.g., English) dialogue, Korean subtitles corresponding to the foreign language dialogue are displayed on a screen (e.g., the display 180), and the Korean subtitles displayed on the display 180 may be output together as voice by the TTS function.

According to an embodiment, when the electronic device 100 simultaneously outputs a plurality of voice signals, the plurality of voice signals output may overlap each other, which may act as a factor that interferes with the user's viewing immersion. Hereinafter, a control method in which the electronic device 100 separates some voice signals into a plurality of audio objects, applies different weights to each separated audio object, and then synthesizes and outputs them in a circumstance in which a plurality of voice signals are simultaneously output is described.

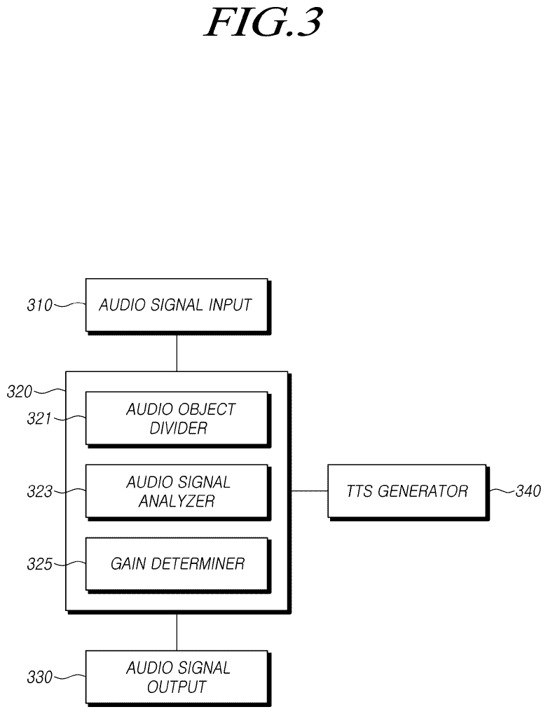

FIG. 3 is a functional block diagram for an electronic device (e.g., the electronic device 100 of FIG. 1) according to an embodiment of the disclosure to separate some of a plurality of audio signals by audio object and synthesize and output the separated audio objects.

The components illustrated in FIG. 3 are illustrated from the perspective of describing a control operation in which the electronic device 100 separates some of a plurality of audio signals by object, applies weights to the separated objects, and then synthesizes and outputs them. The components illustrated in FIG. 3 may be implemented by a processor (e.g., the processor 120 of FIGS. 1 and 2), memory (e.g., the memory 110 of FIGS. 1 and 2), a speaker (e.g., the speaker 170 of FIG. 2), and/or a display (e.g., the display 180 of FIG. 2).

The embodiment of FIG. 3 may be selectively combined with the embodiments of FIGS. 1 and 2.

Referring to FIG. 3, it is assumed that a screen is displayed through the display 180 and voice is output through the speaker 170 by video content in the electronic device 100. For example, an audio signal input to the electronic device 100 by video content is referred to as a first audio signal. The first audio signal may be implemented, e.g., by synthesizing one or more audio objects such as an object corresponding to background sound, an object corresponding to a person's voice, and/or an object corresponding to sound effects.

For example, it is assumed that the voice output from video content includes foreign language dialogue and Korean subtitles corresponding to the foreign language dialogue are displayed on the display 180. For example, the electronic device 100 may output Korean subtitles as voice by activation of the TTS function.

For example, while video content is output, the electronic device 100 may output a notification or a received message to the display 180. For example, the electronic device 100 may output the notification or message as voice by activation of the TTS function.

According to an embodiment, the electronic device 100 may output Korean subtitles or notifications (or messages) as voice according to activation of the TTS function, and accordingly, an audio signal input to the electronic device 100 is referred to as a second audio signal.

Hereinafter, a control process is described in which the electronic device 100 according to the disclosure separates (or classifies) the first audio signal into one or more audio objects when the first audio signal and the second audio signal are simultaneously input, applies different weights to the separated audio objects, and then outputs them with the second audio signal.

According to an embodiment, the electronic device 100 may include an audio signal input 310, an audio signal processor 320, an audio signal output 330, and a TTS generator 340.

According to an embodiment, the audio signal input 310 may be configured to obtain audio signals. For example, the audio signal input 310 may receive a first audio signal generated by video content playback.

According to an embodiment, the TTS generator 340 may generate a second audio signal by activation of the TTS function. For example, the TTS generator 340 may generate a second audio signal by activating a subtitle reading function, or may generate a second audio signal for outputting a notification displayed on the display 180 of the electronic device 100 as voice.

According to an embodiment, the audio signal processor 320 may be configured to process audio signals. For example, the audio signal processor 320 may be configured to process the first audio signal obtained by the audio signal input 310, or to process the second audio signal generated by the TTS generator 340. For example, the audio signal processor 320 may include an audio object divider 321, an audio signal analyzer 323, and a gain determiner 325.

According to an embodiment, the audio object divider 321 may be configured to classify an audio signal into one or more audio objects by components of the audio signal and separate the classified audio objects. For example, the audio object divider 321 may classify and/or separate the first audio signal into one or more audio objects.

According to an embodiment, when the first audio signal includes background music, voice, and sound effects, the audio object divider 321 may classify the first audio signal into a background music object, a voice object, and a sound effect object, respectively, and separate each object.

According to an embodiment, the audio object divider 321 may classify and separate the first audio signal using a machine learning model (e.g., an artificial intelligence model). For example, the audio object divider 321 may classify the first audio signal by object and separate each classified object based on an artificial intelligence model included in the processor 120. The following description schematically describes an operation in which the audio object divider 321 classifies or separates the first audio signal by object using a machine learning model. However, the operations to be described below are merely exemplary, and the audio object divider 321 may separate the first audio signal in various ways.

According to an embodiment, the audio object divider 321 may perform audio pre-processing on the first audio signal. For example, the audio object divider 321 may sequentially convert a predetermined number of time-axis audio data among audio signals to a frequency domain.

According to an embodiment, the audio object divider 321 may convert the audio data to a frequency domain based on fast fourier transform (FFT). However, without limitations thereto, any method capable of converting audio data to a frequency domain may be used.

According to an embodiment, the audio object divider 321 may encode audio data converted to a frequency domain to obtain encoding data. For example, the audio object divider 321 may obtain encoding data by inputting audio data converted to a frequency domain to a first layer of a neural network model.

According to an embodiment, the audio object divider 321 may obtain query data, key data, and value data from the encoding data. For example, the audio object divider 321 may obtain query data, key data, and value data by inputting the encoding data to a second layer of a neural network model.

According to an embodiment, the audio object divider 321 may obtain attention weights and context data based on the query data, key data, and value data. For example, the audio object divider 321 may obtain scored query data by inputting the query data to a third layer of the neural network model, obtain attention weights by element-wise product of the scored query data and key data, and obtain context data by element-wise product of the attention weights and value data.

According to an embodiment, the audio object divider 321 may obtain an object separation mask based on the context data and query data. For example, the processor 120 may obtain an object separation mask by inputting the context data and query data to a fourth layer of the neural network model.

According to an embodiment, the audio object divider 321 may separate the first audio signal into respective audio objects based on the obtained object separation mask. For example, the audio object divider 321 may separate each audio object by applying the obtained object separation mask to an original spectrogram.

According to an embodiment, the audio object divider 321 may separate the first audio signal into a first audio object and a second audio object. For example, the first audio object may correspond to a voice component included in the first audio signal, and the second audio object may correspond to components of the first audio signal except for the first audio object. For example, the second audio object may include background sound, performance sound, and/or sound effects. Therefore, the first audio object may correspond to a voice signal, and the second audio object may correspond to a signal other than a voice signal. In the disclosure, for convenience of description, it is assumed that the first audio signal is separated into two objects, the first audio object and the second audio object, but this is merely exemplary, and the first audio signal may be separated into three or more objects.

According to an embodiment, the audio signal analyzer 323 may analyze the first audio signal and/or the second audio signal. For example, the audio signal analyzer 323 may be configured to analyze the magnitude of the first audio signal and/or the second audio signal, or to analyze playback timing.

For example, the audio signal analyzer 323 may analyze the magnitude of each object of the first audio signal separated by the audio object divider 321.

For example, the audio signal analyzer 323 may analyze the playback timing of the second audio signal. For example, the audio signal analyzer 323 may identify a time when playback of the second audio signal is started and a time when playback of the second audio signal is ended.

According to an embodiment, the gain determiner 325 may determine weights for the first audio signal and/or the second audio signal. For example, the gain determiner 325 may determine weights to be applied to each audio object separated by object for the first audio signal.

For example, the gain determiner 325 may determine different weights for each audio object. For example, the gain determiner 325 may determine different weights for the first audio object and the second audio object. For example, it may be determined to apply a first weight to the first audio object. For example, it may be determined to apply a second weight to the second audio object. For example, the first weight and the second weight may be different from each other.

According to an embodiment, the gain determiner 325 may determine different weights to be applied to the first audio object and the second audio object, respectively, considering overlap with the second audio signal. For example, the gain determiner 325 may determine different weights to be applied to the first audio object and the second audio object, respectively, considering the user's immersion when overlapped with the second audio signal.

According to an embodiment, the gain determiner 325 may apply a relatively small weight to the first audio object similar to the second audio signal. For example, the first weight applied by the gain determiner 325 may be relatively smaller than the second weight.

According to an embodiment, the gain determiner 325 may apply a third weight to the second audio signal. For example, the gain determiner 325 may apply a third weight to the second audio signal considering the magnitude of the first audio object. For example, the third weight may be determined corresponding to the magnitude of the first audio object. For example, the third weight in a section where the magnitude of the first audio object is large may be larger than the third weight in a section where the magnitude of the first audio object is small.

According to an embodiment, the audio signal output 330 may synthesize each audio signal and output the synthesized audio signal. For example, by the audio signal output 330, the first audio object to which the first weight is applied, the second audio object to which the second weight is applied, and the second audio signal to which the third weight is applied may be synthesized, and the synthesized audio signal may be output.

According to an embodiment, the electronic device 100 may enhance immersion in video content by separating the first audio signal by object and applying weights of each audio signal to the separated audio object in consideration of the relationship with the second audio signal. Hereinafter, a technology in which the electronic device 100 of the disclosure separates an audio signal by object and applies weights to each object is referred to as “object-specific audio ducking” technology.

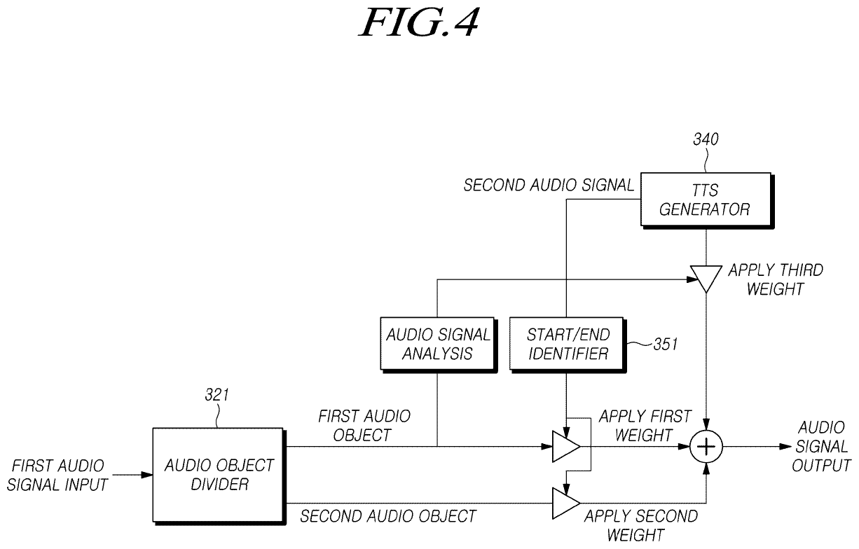

FIG. 4 illustrates a process in which an electronic device (e.g., the electronic device 100 of FIG. 1) according to an embodiment of the disclosure performs object-specific audio ducking on an audio signal.

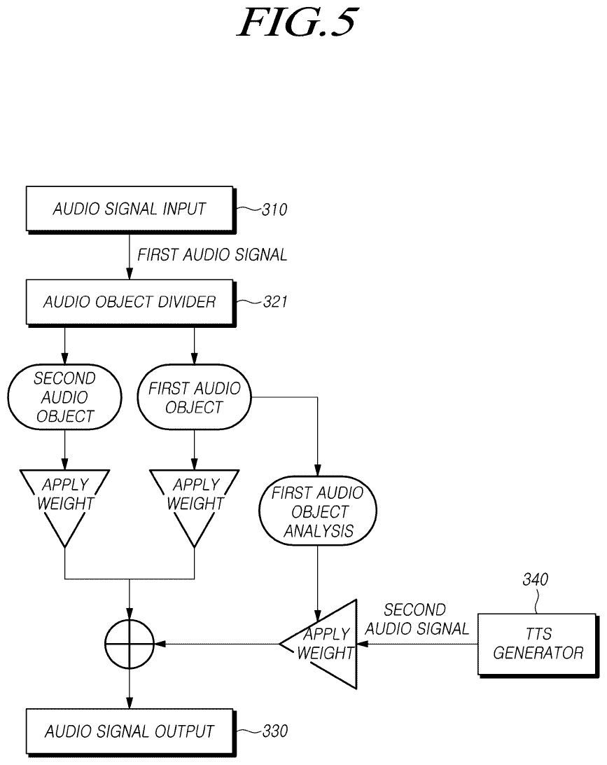

FIG. 5 illustrates a process in which the electronic device 100 according to an embodiment of the disclosure performs object-specific audio ducking on an audio signal.

FIGS. 3 and 4 may be understood as illustrating an embodiment of an operation in which the electronic device 100 applies weights by object to the first audio signal and the second audio signal and outputs them.

Referring to FIGS. 3 and 4, the electronic device 100 may separate the first audio signal by object. For example, the first audio signal may be separated into a first audio object and a second audio object by the audio object divider 321 (e.g., the audio object divider 321 of FIG. 3). For example, the first audio object may correspond to a voice signal, and the second audio object may correspond to an audio signal except for the voice signal.

According to an embodiment, the electronic device 100 may obtain a second audio signal. For example, the electronic device 100 may obtain a second audio signal by the TTS generator 340 (e.g., the TTS generator 340 of FIG. 3) in response to activation of the TTS function. For example, the TTS generator 340 may obtain a second audio signal when characters are displayed on a display (e.g., the display 180 of FIG. 2) by activation of the TTS function. Accordingly, the second audio signal corresponds to a voice signal of the TTS function.

According to an embodiment, a weight may be applied to each of the first audio object and the second audio object. For example, the gain determiner 325 (e.g., the gain determiner 325 of FIG. 3) may apply weights to the first audio object and the second audio object, respectively. For example, a first weight may be applied to the first audio object by the gain determiner 325. For example, a second weight may be applied to the second audio object by the gain determiner 325.

According to an embodiment, the first weight and the second weight may be different from each other. For example, the first weight and the second weight may be determined considering the second audio signal.

According to an embodiment, the first weight may be determined to be a relatively smaller value than the second weight.

According to an embodiment, the first weight and the second weight may be determined considering a section where the second audio signal is present. For example, the audio signal analyzer (e.g., the audio signal analyzer 323 of FIG. 3) may identify a start time and an end time of the second audio signal. For example, the audio signal analyzer 323 may identify a start identifier and an end identifier 351 included in the second audio signal, and identify the start time and end time of the second audio signal by the identifiers 351.

According to an embodiment, the electronic device 100 may apply the first weight and the second weight to the first audio object and the second audio object, respectively, during a section where the second audio signal is present. For example, the electronic device 100 may apply the first weight and the second weight to the first audio object and the second audio object, respectively, only when TTS sound is played.

According to an embodiment, the electronic device 100 may apply the first weight and the second weight to the first audio object and the second audio object, respectively, regardless of whether the second audio signal is present. For example, the electronic device 100 may adjust the magnitude of the first audio object and the second audio object even in sections where TTS sound is not present.

According to an embodiment, the electronic device 100 may apply a weight to the second audio signal. For example, the gain determiner 325 may apply a third weight to the second audio signal.

Hereinafter, a control flowchart for a method for the electronic device 100 to perform an object-specific audio ducking technique is described.

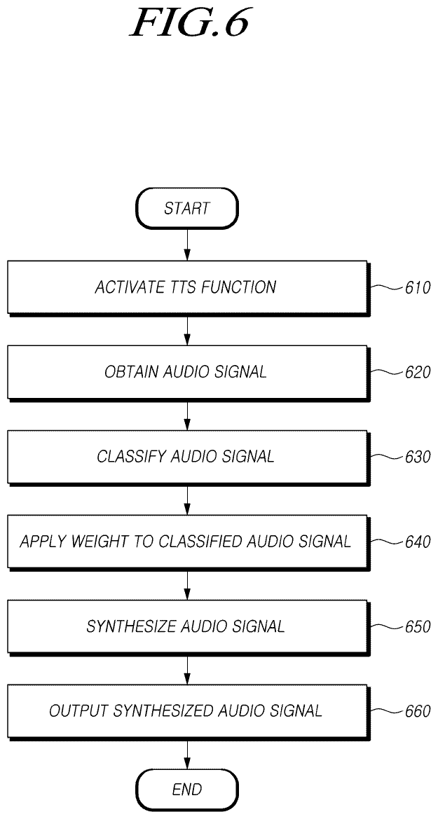

FIG. 6 is a schematic control flowchart for an electronic device (e.g., the electronic device 100 of FIG. 1) according to an embodiment of the disclosure to perform an object-specific audio ducking technique.

The embodiment of FIG. 6 may be selectively combined with the embodiment of FIGS. 1 to 5.

Referring to FIG. 6, the electronic device 100 may activate the TTS function in step 610. For example, the electronic device 100 may activate the TTS function by receiving a user input. For example, the electronic device 100 may activate the TTS function when a predetermined event occurs. The predetermined event may be, e.g., an event set by the user or an event pre-stored in memory (e.g., the memory 110 of FIG. 1).

For example, the electronic device 100 may activate the TTS function by an event where subtitles are output when playing video content. For example, the electronic device 100 may activate the TTS function when displaying a notification on the display 180. For example, the electronic device 100 may activate the TTS function when executing a specific application.

According to an embodiment, the electronic device 100 may obtain an audio signal in step 620. For example, the electronic device 100 may obtain a first audio signal and a second audio signal.

According to an embodiment, the electronic device 100 may classify the audio signal in step 630. For example, the electronic device 100 may classify the first audio signal by object. For example, the electronic device 100 may classify the first audio signal into a first audio object corresponding to a voice signal and a second audio object corresponding to the first audio signal except for the first audio object.

According to an embodiment, the electronic device 100 may apply weights to the classified audio signals in step 640. For example, the electronic device 100 may apply weights to the first audio object and second audio object included in the first audio signal and the second audio signal, respectively. For example, the electronic device 100 may apply a first weight to the first audio object. For example, the electronic device 100 may apply a second weight to the second audio object-For example, the electronic device 100 may apply a third weight to the second audio signal.

According to an embodiment, the electronic device 100 may synthesize the audio signals in step 650. For example, the electronic device 100 may synthesize the first audio object to which the first weight is applied, the second audio object to which the second weight is applied, and the second audio signal to which the third weight is applied.

According to an embodiment, the electronic device 100 may output the synthesized audio signal in step 660. For example, the electronic device 100 may output the synthesized audio signal through the audio signal output (e.g., the audio signal output 330 of FIG. 3).

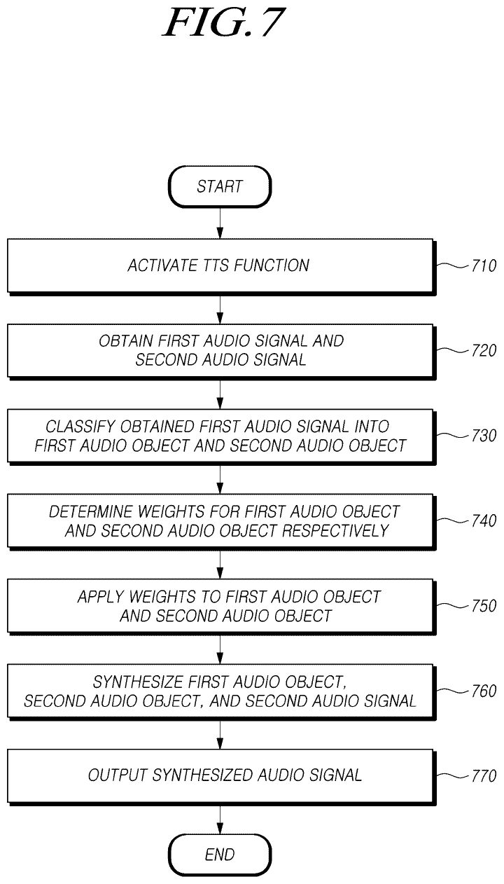

FIG. 7 is a control flowchart for an electronic device (e.g., the electronic device 100 of FIG. 1) according to an embodiment of the disclosure to perform an object-specific audio ducking technique.

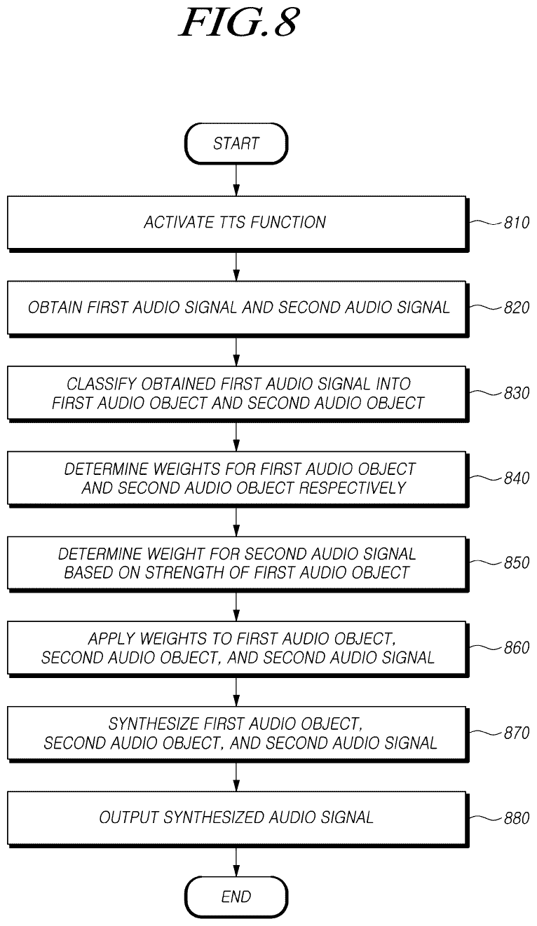

FIG. 8 is a control flowchart for the electronic device 100 according to an embodiment of the disclosure to perform an object-specific audio ducking technique.

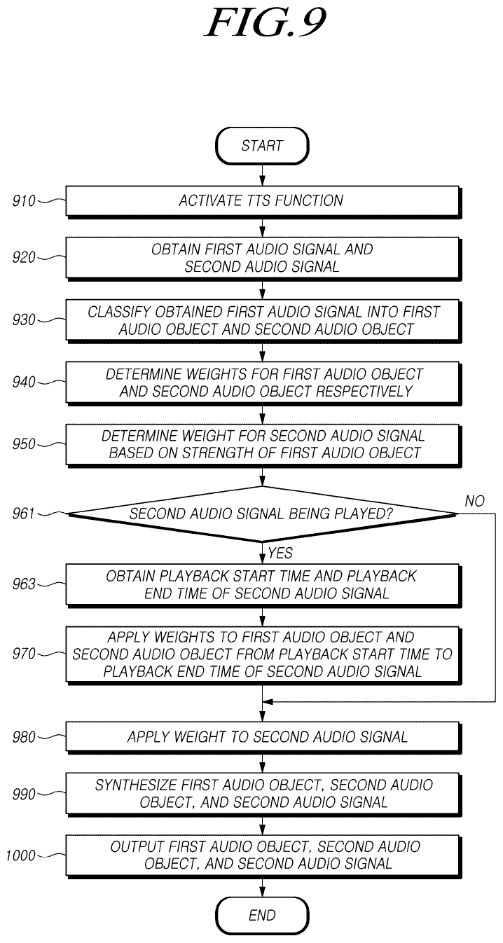

FIG. 9 is a control flowchart for the electronic device 100 according to an embodiment of the disclosure to perform an object-specific audio ducking technique.

The control flowcharts illustrated in FIGS. 7 to 9, respectively, are illustrated to describe differences in detailed operations when the electronic device 100 performs an object-specific audio ducking technique. For example, FIG. 7 illustrates a control flowchart for a case where the electronic device 100 does not apply a separate weight to the second audio signal (e.g., voice generated by the TTS function), and FIGS. 8 and 9 illustrate control flowcharts for cases where the electronic device 100 applies a separate weight to the second audio signal. However, FIGS. 8 and 9 are shown differently according to whether a section where the second audio signal is played is considered when applying weights to the first audio object and the second audio object, respectively, included in the first audio signal. Hereinafter, the differences in the detailed operations mentioned above are mainly described.

Some of the operations illustrated in FIGS. 7 to 9 may be omitted, the same operations may be repeatedly performed, and the order of operations may be changed as needed.

The embodiments of FIGS. 7 to 9 may be selectively combined with the embodiment of FIG. 6.

Referring to FIG. 7, the electronic device 100 may activate the TTS function in operation 710. For example, operation 710 may correspond to operation 610 of FIG. 6.

According to an embodiment, the electronic device 100 may obtain a first audio signal and a second audio signal in operation 720. For example, operation 720 may correspond to operation 620 of FIG. 6.

According to an embodiment, the electronic device 100 may classify the obtained first audio signal into a first audio object and a second audio object in operation 730. For example, operation 730 may correspond to operation 630 of FIG. 6.

According to an embodiment, the electronic device 100 may determine weights for the first audio object and the second audio object, respectively, in operation 740. For example, operation 740 may correspond to operation 640 of FIG. 6.

According to an embodiment, the electronic device 100 may determine different weights for the first audio object and the second audio object. For example, the first weight may be relatively smaller than the second weight. As a result, the first audio object corresponding to the voice signal may be output at a level smaller than the second audio object corresponding to background sound or sound effects.

According to an embodiment, the electronic device 100 may apply a first weight to the first audio object in operation 750. The electronic device 100 may apply a second weight to the second audio object.

According to an embodiment, the electronic device 100 may synthesize the first audio object, the second audio object, and the second audio signal in operation 760. For example, operation 760 may correspond to operation 650 of FIG. 6.

According to an embodiment, the electronic device 100 may output the synthesized audio signal in operation 770. For example, operation 770 may correspond to operation 660 of FIG. 6.

Referring to FIG. 8, the electronic device 100 may activate the TTS function in operation 810. For example, operation 810 may correspond to operation 610 of FIG. 6 and operation 710 of FIG. 7.

According to an embodiment, the electronic device 100 may obtain a first audio signal and a second audio signal in operation 820. For example, operation 820 may correspond to operation 620 of FIG. 6 and operation 720 of FIG. 7.

According to an embodiment, the electronic device 100 may classify the obtained first audio signal into a first audio object and a second audio object in operation 830. For example, operation 830 may correspond to operation 630 of FIG. 6 and operation 730 of FIG. 7.

According to an embodiment, the electronic device 100 may determine weights for the first audio object and the second audio object, respectively, in operation 840. For example, operation 840 may correspond to operation 640 of FIG. 6 and operation 740 of FIG. 7.

According to an embodiment, the electronic device 100 may determine a weight for the second audio signal based on the strength of the first audio object in operation 850. For example, the electronic device 100 may consider the strength of the first audio object when determining a third weight for the second audio signal. Here, the signal strength of the first audio object may mean the signal strength of the first audio object in a state in which the first weight is not applied (assigned). For example, the electronic device 100 may determine the third weight corresponding to the signal strength (e.g., amplitude) of the first audio object corresponding to the voice signal included in the first audio signal. For example, the signal strength of the first audio object may have a positive correlation with the third weight.

According to an embodiment, the electronic device 100 may apply weights to the first audio object, the second audio object, and the second audio signal in operation 860. For example, operation 860 may correspond to operation 640 of FIG. 6 and operation 750 of FIG. 7.

According to an embodiment, the electronic device 100 may apply a first weight to the first audio object, apply a second weight to the second audio object, and apply a third weight to the second audio signal.

According to an embodiment, the electronic device 100 may synthesize the first audio object, the second audio object, and the second audio signal in operation 870. For example, operation 870 may correspond to operation 650 of FIG. 6 and operation 760 of FIG. 7.

According to an embodiment, the electronic device 100 may output the synthesized audio signal in operation 880. For example, operation 880 may correspond to operation 660 of FIG. 6 and operation 770 of FIG. 7.

Referring to FIG. 9, the electronic device 100 may activate the TTS function in operation 910. For example, operation 910 may correspond to operation 610 of FIG. 6, operation 710 of FIG. 7, and operation 810 of FIG. 8.

According to an embodiment, the electronic device 100 may obtain a first audio signal and a second audio signal in operation 920. For example, operation 920 may correspond to operation 620 of FIG. 6, operation 720 of FIG. 7, and operation 820 of FIG. 8.

According to an embodiment, the electronic device 100 may classify the obtained first audio signal into a first audio object and a second audio object in operation 930. For example, operation 930 may correspond to operation 630 of FIG. 6, operation 730 of FIG. 7, and operation 830 of FIG. 8.

According to an embodiment, the electronic device 100 may determine weights for the first audio object and the second audio object, respectively, in operation 940. For example, operation 940 may correspond to operation 740 of FIG. 7 and operation 840 of FIG. 8.

According to an embodiment, the electronic device 100 may apply a weight to the second audio signal based on the strength of the first audio object in operation 950. For example, operation 950 may correspond to operation 640 of FIG. 6, operation 740 of FIG. 7, and operation 840 of FIG. 8.

According to an embodiment, the electronic device 100 may determine whether the second audio signal is being played in operation 961.

According to an embodiment, when the electronic device 100 determines that the second audio signal is being played, it may obtain a playback start time and a playback end time of the second audio signal in operation 963. For example, the electronic device 100 may obtain the playback start time and playback end time of the second audio signal by identifying a playback start identifier and a playback end identifier (e.g., the start/end identifier 351 of FIG. 4) for the second audio signal using the audio signal analyzer (e.g., the audio signal analyzer 323 of FIG. 3).

According to an embodiment, the electronic device 100 may apply weights to the first audio object and the second audio object, respectively, from the playback start time to the playback end time of the second audio signal in operation 970.

According to an embodiment, the electronic device 100 may apply a weight to the second audio signal in operation 980. For example, the electronic device 100 may apply a third weight to the second audio signal corresponding to the signal strength of the first audio object. For example, operation 980 may correspond to operation 850 of FIG. 8.

According to an embodiment, when the electronic device 100 determines that the second audio signal is not being played, it may apply a weight to the second audio signal in operation 965. For example, when the electronic device 100 determines that the second audio signal is not being played, it may omit operations 963 and 970.

According to an embodiment, the electronic device 100 may synthesize the first audio object, the second audio object, and the second audio signal in operation 990. For example, operation 990 may correspond to operation 650 of FIG. 6, operation 760 of FIG. 7, and operation 870 of FIG. 8.

According to an embodiment, the electronic device 100 may output the synthesized audio signal in operation 1000. For example, operation 1000 may correspond to operation 660 of FIG. 6, operation 770 of FIG. 7, and operation 880 of FIG. 8.

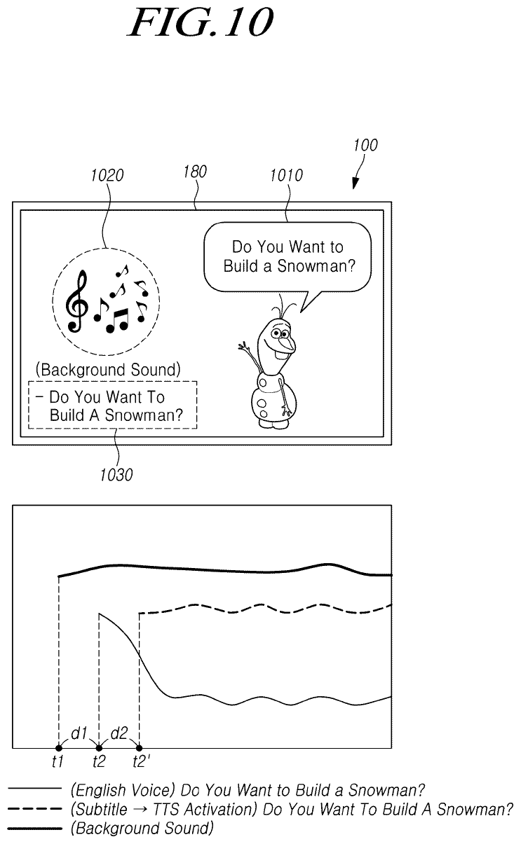

FIG. 10 exemplarily illustrates a scenario in which the electronic device 100 (e.g., the electronic device 100 of FIG. 1) according to an embodiment of the disclosure performs object-specific audio ducking.

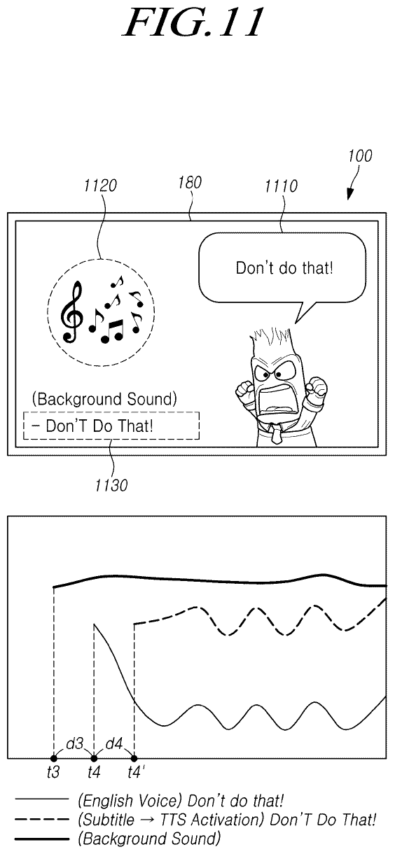

FIG. 11 exemplarily illustrates a scenario in which the electronic device 100 according to an embodiment of the disclosure performs object-specific audio ducking.

FIGS. 10 and 11 exemplarily illustrate an embodiment in which object-specific audio ducking is performed while video content is being played on a display (e.g., the display 180 of FIG. 2) of the electronic device 100.

The embodiments of FIGS. 10 and 11 may be selectively combined with the embodiments of FIGS. 1 to 9.

Referring to FIGS. 10 and 11, video content played on the display 180 may be multimedia content including various types of information. For example, the video content may include audio, video, and/or animation.

According to an embodiment, the audio signal may include a voice component 1010; 1110 from dialogue of characters in the content and a background sound component 1020; 1120. The audio signal may correspond to the above-described first audio signal.

According to an embodiment, when the voice component 1010; 1110 is in a foreign language and the subtitle function is activated, the electronic device 100 may display subtitles corresponding to the voice component 1010; 1110 as text 1030; 1130 on the display 180.

According to an embodiment, the electronic device 100 may generate TTS voice corresponding to the text 1030; 1130 in response to activation of the TTS function. The TTS voice may correspond to the above-described second audio signal. In other words, the second audio signal corresponds to a voice signal of the TTS function.

According to an embodiment, when the voice component 1010; 1110 included in the first audio signal and the TTS voice are overlapped and output, viewing immersion may be decreased. Therefore, the electronic device 100 may perform object-specific audio ducking.

According to an embodiment, the electronic device 100 may separate the first audio signal into a first audio object corresponding to the voice component 1010; 1110 and a second audio object corresponding to the background sound component 1020; 1120.

According to an embodiment, the electronic device 100 may apply weights to the first audio object and the second audio object. For example, the electronic device 100 may apply a first weight to the first audio object and apply a second weight to the second audio object.

According to an embodiment, the electronic device 100 may determine the first weight and the second weight considering the degree of association with the second audio signal. For example, the electronic device 100 may determine the first weight to be a smaller value than the second weight in order to output the signal magnitude of the first audio object, which is a factor that more interferes with the user's immersion when overlapped with the TTS voice, to be smaller.

According to an embodiment, the electronic device 100 may obtain a start time and an end time of the second audio signal and apply the first weight and the second weight for a section where the second audio signal is output. However, when the first weight and the second weight are applied only to a section where the second audio signal is output, the magnitude deviation of the voice component output corresponding to the presence or absence of the second audio signal output may not be consistent. For example, according to whether TTS voice is output, a phenomenon may occur where the voice component is output at a smaller or larger level. As a result, when the second audio signal is generated by the voice component (e.g., dialogue), the electronic device 100 may apply the first weight and the second weight considering a start time and an end time when the second audio signal is generated by the voice component.

According to an embodiment, the electronic device 100 may apply a third weight to the second audio signal. For example, the electronic device 100 may determine the third weight considering the signal magnitude of the first audio object.

For example, the electronic device 100 may determine the third weight for the second audio signal to be small for a section where the voice component 1010; 1110 is output at a small level (e.g., when a character in the video whispers or mutters). For example, the electronic device 100 may determine the third weight for the second audio signal to be large for a section where the voice component 1010; 1110 is output at a large level (e.g., when a character in the video shouts or gets angry).

Referring to FIG. 10, the background sound component 1020 may be output from time t1, the voice component 1010 may be output from time t2 after a delay d1 elapses from time t1, and TTS voice generated by the text 1030 may be output from time t2′ after a delay d2 elapses from time t2.

Referring to FIG. 11, the background sound component 1120 may be output from time t3, the voice component 1110 may be output from time t4 after a delay d3 elapses from time t3, and TTS voice generated by the text 1130 may be output from time t4′ after a delay d4 elapses from time t4.

According to an embodiment, the electronic device 100 may enhance recognition of TTS voice and provide an immersive viewing environment by separating the first audio signal by object and applying first and second weights, which are different, considering the second audio signal to each object, and applying a third weight considering the magnitude of the voice component 1010; 1110 included in the first audio signal to the second audio signal.

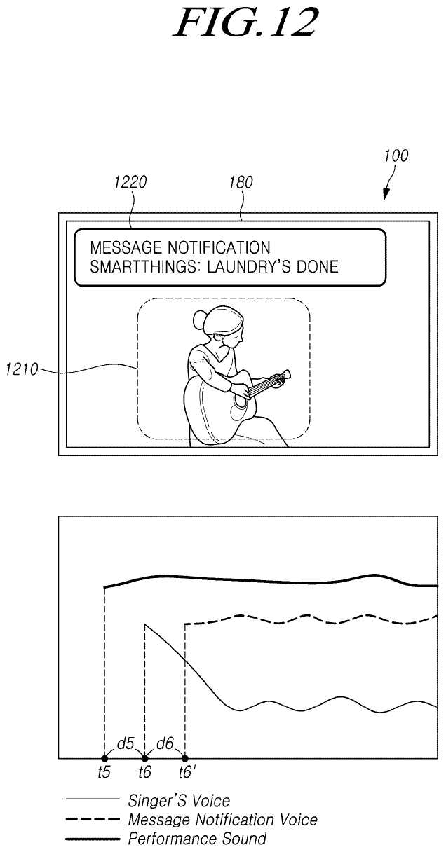

FIG. 12 exemplarily illustrates a scenario in which the electronic device 100 according to an embodiment of the disclosure performs object-specific audio ducking.

FIG. 12 exemplarily illustrates an embodiment in which object-specific audio ducking is performed while video content is being played on a display (e.g., the display 180 of FIG. 2) of the electronic device 100. For example, an embodiment is illustrated in which information (e.g., a received message or notification) displayed on the display 180 while video content is being played is output as TTS voice.

Referring to FIG. 12, video content played on the display 180 may be multimedia content including various types of information. For example, the video content may include audio, video, and/or animation. For example, the video content may be video content of a band composed of singers and performers performing musical instruments while singing.

According to an embodiment, the audio signal may include a voice component and a background sound component. The audio signal may correspond to the above-described first audio signal. The first audio signal may include, e.g., a voice component corresponding to a singer's vocal and background sound corresponding to performance sound.

According to an embodiment, the electronic device 100 may output information displayed on the display 180 as TTS voice in response to activation of the TTS function. For example, the received information may include messages received by the electronic device 100 from external devices or information generated by the electronic device 100. The TTS voice may correspond to the above-described second audio signal.

According to an embodiment, when the voice component included in the first audio signal and the TTS voice are overlapped and output, viewing immersion may be decreased. Therefore, the electronic device 100 may perform object-specific audio ducking.

According to an embodiment, the electronic device 100 may separate the first audio signal into a first audio object corresponding to the voice component and a second audio object corresponding to the background sound component.

According to an embodiment, the electronic device 100 may apply weights to the first audio object and the second audio object. For example, the electronic device 100 may apply a first weight to the first audio object and apply a second weight to the second audio object.

According to an embodiment, the electronic device 100 may determine the first weight and the second weight considering the degree of association with the second audio signal. For example, the electronic device 100 may determine the first weight to be a smaller value than the second weight in order to output the signal magnitude of the first audio object, which is a factor that more interferes with the user's immersion when overlapped with the TTS voice, to be smaller. However, the electronic device 100 may determine the first weight and the second weight considering the relationship between the first audio object included in the first audio signal and the second audio signal. For example, the electronic device 100 may determine the first weight and the second weight to be substantially the same considering that the first audio signal is music composed of vocal voice and performance sound.

According to an embodiment, the electronic device 100 may obtain a start time and an end time of the second audio signal and apply the first weight and the second weight for a section where the second audio signal is output. However, when the first weight and the second weight are applied only to a section where the second audio signal is output, the magnitude deviation of the voice component output corresponding to the presence or absence of the second audio signal output may not be consistent. For example, according to whether TTS voice is output, a phenomenon may occur where the voice component is output at a smaller or larger level. As a result, the electronic device 100 may apply the first weight and the second weight considering a start time and an end time when the second audio signal is generated by the voice component.

According to an embodiment, the electronic device 100 may apply a third weight to the second audio signal. For example, the electronic device 100 may determine the third weight considering the signal magnitude of the first audio object.

According to an embodiment, the electronic device 100 may determine the third weight considering the relationship between the first audio object included in the first audio signal and the second audio signal. The electronic device 100 may determine the third weight considering that the first audio signal is music composed of vocal voice and performance sound.

Referring to FIG. 12, the background sound component may be output from time t5, the voice component may be output from time t6 after a delay d5 elapses from time t5, and TTS voice generated by the received message 1220 may be output from time t6′ after a delay d6 elapses from time t6.

According to an embodiment, the electronic device 100 may enhance recognition of TTS voice and provide an immersive viewing environment by separating the first audio signal by object and applying first and second weights, which are different considering the second audio signal to each object, and applying a third weight considering the voice component included in the first audio signal to the second audio signal.

The electronic device 100 according to an embodiment of the disclosure may provide object-specific audio ducking technology that separates audio signals by object and determines weights by object considering TTS voice.

The electronic device 100 according to an embodiment of the disclosure may separate audio objects for each voice signal and adjust and output sound for audio objects with high relevance when outputting a plurality of voice signals.

The electronic device 100 according to an embodiment of the disclosure may increase the user's immersion when watching videos by outputting separated audio objects with different weights applied thereto.

The electronic device 100 according to an embodiment of the disclosure may enhance the recognition level for TTS signals by performing object-specific audio ducking considering TTS voice.

Effects obtainable from the disclosure are not limited to the above-mentioned effects, and other effects not mentioned may be apparent to one of ordinary skill in the art from the following description.

An electronic device (e.g., the electronic device (100) of FIG. 1) according to an embodiment of the disclosure may include one or more processors 120, and memory 110 storing instructions. The instructions may, when executed individually or collectively by the one or more processors 120, cause the electronic device (100) to activate a text to speech (TTS) function (610; 710; 810; 910), obtain a first audio signal generated in response to playing video content (620; 720; 820; 920), obtain a second audio signal generated in response to activating the TTS function (620; 720; 820; 920), in response to activating the TTS function, classify the first audio signal into a first audio object and a second audio object (630; 730; 830; 930), determine a first weight for the first audio object and a second weight for the second audio object (640; 740, 750; 840; 940) wherein the first weight and the second weight are different, apply the first weight to the first audio object and the second weight to the second audio object, synthesize the first audio object with the first weight applied thereto, the second audio object with the second weight applied thereto, and the second audio signal (650, 660; 760, 770; 870, 880; 990, 1000) together into a synthesized audio signal, and output the synthesized audio signal. The first audio object may be a signal of a type similar to the second audio signal compared to the second audio object. More specifically, the first audio object and the second audio signal may correspond to a same type of signal, and the second audio object may correspond to a different type of signal than the first audio object and the second audio signal. As an example, the first audio object and the second audio signal may correspond to voice signals, and the second audio object may correspond to a signal other than a voice signal.

In the electronic device 100 according to an embodiment of the disclosure, the first audio object may correspond to a voice signal among the audio signals.

In the electronic device 100 according to an embodiment of the disclosure, the second audio object may correspond to a signal except for the first audio object among the audio signals.

In the electronic device 100 according to an embodiment of the disclosure, the first weight may be smaller than the second weight.

In the electronic device 100 according to an embodiment of the disclosure, the instructions may, when executed individually or collectively by the one or more processors 120, cause the electronic device 100 to determine a third weight for the second audio signal (640; 750; 850; 950).

In the electronic device 100 according to an embodiment of the disclosure, the instructions may, when executed individually or collectively by the one or more processors 120, cause the electronic device 100 to determine the third weight based on a signal strength of the first audio object (850; 950).

In the electronic device 100 according to an embodiment of the disclosure, the third weight may have a positive correlation with the signal strength of the first audio object.

In the electronic device 100 according to an embodiment of the disclosure, the instructions may, when executed individually or collectively by the one or more processors 120, cause the electronic device 100 to obtain a first time when output of the second audio signal is started and a second time when output of the second audio signal is ended (963) and apply the first weight and the second weight to the first audio object and the second audio object, respectively, output during the first time and the second time (970).

In the electronic device 100 according to an embodiment of the disclosure, the instructions may, when executed individually or collectively by the one or more processors 120, cause the electronic device 100 to apply the second weight to the second audio object output during the first time and the second time (980).

In the electronic device 100 according to an embodiment of the disclosure, the memory 110 may be configured to store a neural network model obtained by learning relationships between a plurality of sample audio signals and the plurality of sample audio objects.

A method for controlling an electronic device 100 according to an embodiment of the disclosure may comprise activating a text to speech (TTS) function (610; 710; 810; 910), obtaining a first audio signal generated in response to playing video content (620; 720; 820; 920), obtaining a second audio signal generated in response to activating the TTS function (620; 720; 820; 920), in response to activating the TTS function, classifying the first audio signal into a first audio object and a second audio object (630; 730; 830; 930), determining a first weight for the first audio object and a second weight for the second audio object (640; 740, 750; 840; 940), wherein the first weight and the second weight are different, applying the first weight to the first audio object and the second weight to the second audio object, synthesizing the first audio object with the first weight applied thereto, the second audio object with the second weight applied thereto, and the second audio signal together into a synthesized audio signal, and outputting the synthesized audio signal (650, 660; 760, 770; 870, 880; 990, 1000). The first audio object may be a signal of a type similar to the second audio signal compared to the second audio object.

In the method for controlling the electronic device 100 according to an embodiment of the disclosure, the first audio object may correspond to a voice signal among the audio signals.

In the method for controlling the electronic device 100 according to an embodiment of the disclosure, the second audio object may correspond to a signal except for the first audio object among the audio signals.

In the method for controlling the electronic device 100 according to an embodiment of the disclosure, the first weight may be smaller than the second weight.

The method for controlling an electronic device 100 according to an embodiment of the disclosure may include determining a third weight for the second audio signal (640; 750; 850; 950).

The method for controlling an electronic device 100 according to an embodiment of the disclosure may include determining the third weight based on a signal strength of the first audio object (850; 950).

In the method for controlling the electronic device 100 according to an embodiment of the disclosure, the third weight may have a positive correlation with the signal strength of the first audio object.

The method for controlling an electronic device 100 according to an embodiment of the disclosure may include obtaining a first time when output of the second audio signal is started and a second time when output of the second audio signal is ended (963) and applying the first weight to the first audio object output during the first time and the second time (970).

The method for controlling an electronic device 100 according to an embodiment of the disclosure may include applying the second weight to the second audio object output during the first time and the second time (980).

In the method for controlling the electronic device 100 according to an embodiment of the disclosure, the classifying the first audio signal (630) may include classifying the first audio signal into the first audio object and the second audio object using a neural network model obtained by learning relationships between a plurality of sample audio signals and the plurality of sample audio objects.

1. An electronic device comprising:
one or more processors; and
memory storing instructions that, when executed individually or collectively by the one or more processors, cause the electronic device to:
activate a text to speech (TTS) function;
obtain a first audio signal generated in response to playing a video content;
obtain a second audio signal generated in response to activating the TTS function;
in response to activating the TTS function, classify the first audio signal into a first audio object and a second audio object;
determine a first weight for the first audio object and a second weight for the second audio object, wherein the first weight and the second weight are different;
apply the first weight to the first audio object and the second weight to the second audio object;
synthesize the first audio object with the first weight applied thereto, the second audio object with the second weight applied thereto, and the second audio signal together into a synthesized audio signal; and
output the synthesized audio signal,
wherein the first audio object and the second audio signal correspond to a same type of signal, and the second audio object corresponds to a different type of signal than the first audio object and the second audio signal.

2. The electronic device of claim 1, wherein the first audio object corresponds to a voice signal.

3. The electronic device of claim 2, wherein the second audio object corresponds to a signal other than a voice signal.

4. The electronic device of claim 1, wherein the first weight is smaller than the second weight.

5. The electronic device of claim 1, wherein the instructions, when executed individually or collectively by the one or more processors, cause the electronic device to:
determine a third weight for the second audio signal.

6. The electronic device of claim 5, wherein the instructions, when executed individually or collectively by the one or more processors, cause the electronic device to:
determine the third weight based on a signal strength of the first audio object.

7. The electronic device of claim 6, wherein the third weight has a positive correlation with the signal strength of the first audio object.

8. The electronic device of claim 5, wherein the instructions, when executed individually or collectively by the one or more processors, cause the electronic device to:
obtain a first time when output of the second audio signal is started and a second time when output of the second audio signal is ended, and
apply the first weight and the second weight to the first audio object and the second audio object, respectively, output during the first time and the second time.

9. The electronic device of claim 8, wherein the instructions, when executed individually or collectively by the one or more processors, cause the electronic device to:
apply the second weight to the second audio object output during the first time and the second time.

10. The electronic device of claim 1, wherein the memory is configured to store a neural network model obtained by learning relationships between a plurality of sample audio signals and a plurality of sample audio objects.

11. A method comprising:
activating a text to speech (TTS) function;
obtaining a first audio signal generated in response to playing a video content;
obtaining a second audio signal generated in response to activating the TTS function;
in response to activating the TTS function, classifying the first audio signal into a first audio object and a second audio object;
determining a first weight for the first audio object and a second weight for the second audio object, wherein the first weight and the second weight are different;
applying the first weight to the first audio object and the second weight to the second audio object;
synthesizing the first audio object with the first weight applied thereto, the second audio object with the second weight applied thereto, and the second audio signal together into a synthesized audio signal; and
outputting the synthesized audio signal,
wherein the first audio object and the second audio signal correspond to a same type of signal, and the second audio object corresponds to a different type of signal than the first audio object and the second audio signal.

12. The method of claim 11, wherein the first audio object corresponds to a voice signal.

13. The method of claim 12, wherein the second audio object corresponds to a signal other than a voice signal.

14. The method of claim 11, wherein the first weight is smaller than the second weight.

15. The method of claim 11, further comprising:
determining a third weight for the second audio signal.

16. The method of claim 15, further comprising:
determining the third weight based on a signal strength of the first audio object.

17. The method of claim 16, wherein the third weight has a positive correlation with the signal strength of the first audio object.

18. The method of claim 15, further comprising:
obtaining a first time when output of the second audio signal is started and a second time when output of the second audio signal is ended; and
applying the first weight to the first audio object output during the first time and the second time.

19. The method of claim 18, further comprising:
applying the second weight to the second audio object output during the first time and the second time.

20. The method of claim 11, wherein the classifying the first audio signal includes classifying the first audio signal into the first audio object and the second audio object using a neural network model obtained by learning relationships between a plurality of sample audio signals and a plurality of sample audio objects.
